(19) United States
(12) Patent Application Publication
(10) Pub. No.: US 2007/0011851 A1
(43) Pub. Date: Jan. 18, 2007

(54) ROPE DEVICE

(76) Inventor: Chih-Hsin Wang, Lungching Shiang (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/160,831

(22) Filed: Jul. 12, 2005

(51) Int. Cl. F16G 11/00

(52) U.S. Cl. 24/136 R

(57) ABSTRACT

There is disclosed a rope device for tying a pet. The rope device includes a clamp, a rope and a cam. The clamp defines a channel and a recess communicated with the channel. The rope includes a first end connected to the clamp and a second end inserted through the channel. The cam is put in the recess. The cam includes a pivotal point, a furthest point from the pivotal point, and a nearest point from the pivotal point. As the rope is pulled in a direction, the cam is rotated in order to move the furthest point from the rope so as to allow the rope to move between the wall of the channel and the cam. As the rope is pulled in an opposite direction, the cam is rotated in order to move the furthest point towards the rope so as to pinch the rope between the wall of the channel and the cam.

### BACKGROUND OF INVENTION

1. Field of Invention

The present invention relates to a rope device for tying a pet and, more particularly, to a rope device with an adjustable effective length.

2. Related Prior Art

Referring to FIG. 11 of Taiwanese Patent Publication No. 583907, there is shown a typical rope device for tying a pet. The typical rope device includes a rope 30, a loop 31 formed at an end of the rope 30, and a hook 32 attached to an opposite end of the rope 30. The effective length of the conventional rope device cannot be adjusted.

Referring to the other drawings of the same Taiwanese patent, there is shown a conventional rope device. The conventional rope device includes a composite rope, a loop 4 connected to an end of the composite rope, a hook 27 connected to an opposite end of the composite rope, and a length adjustor for adjusting the effective length of the composite rope. The composite rope includes a steel rope 3 and an illuminant sheath 25 for enclosing the steel rope 3. However, the structure of the length adjustor is complicated.

The present invention is therefore intended to obviate or at least alleviate the problems encountered in prior art.

### SUMMARY OF INVENTION

According to the present invention, there is disclosed a rope device for tying a pet. The rope device includes a clamp, a rope and a cam. The clamp defines a channel and a recess communicated with the channel. The rope includes a first end connected to the clamp and a second end inserted through the channel. The cam is put in the recess. The cam includes a pivotal point, a furthest point from the pivotal point, and a nearest point from the pivotal point. As the rope is pulled in a direction, the cam is rotated in order to move the furthest point from the rope so as to allow the rope to move between the wall of the channel and the cam. As the rope is pulled in an opposite direction, the cam is rotated in order to move the furthest point towards the rope so as to pinch the rope between the wall of the channel and the cam.

An advantage of the rope device according to the present invention is to avoid increasing of the effective length of the rope by a pet but allow reducing of the effective length of the rope by an owner of the pet.

Another advantage of the rope device according to the present invention is its easy and reliable operation.

Still another advantage of the rope device according to the present invention is its low cost.

Other advantages and novel features of the invention will become more apparent from the following detailed description in conjunction with the drawings.

### BRIEF DESCRIPTION OF DRAWINGS

The present invention will be described through detailed illustration of the preferred embodiment referring to the drawings.

FIG. 1 is a perspective view of a rope device according to the preferred embodiment of the present invention.

FIG. 2 is an exploded view of the rope device shown in FIG. 1.

FIG. 3 is a cross-sectional view of the rope device shown in FIG. 1.

FIG. 4 is similar to FIG. 3 but shows the rope device in another position.

FIG. 5 is similar to FIG. 4 but shows the rope device in another position.

FIG. 6 is a perspective view of a dog tied to a rail by means of the rope device shown in FIG. 1.

### DETAILED DESCRIPTION OF PREFERRED EMBODIMENT

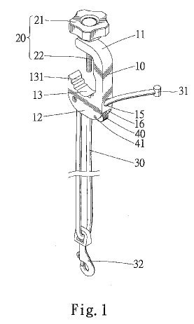

Referring to FIG. 1, there is shown a rope device according to the preferred embodiment of the present invention. The rope device includes a clamp, a rope 30, and a length adjustor 40.

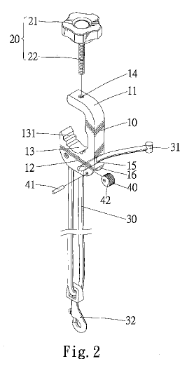

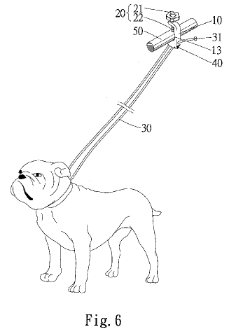

Referring to FIG. 2, the clamp includes a C-shaped body 10 and a fastener 20 connected to the C-shaped body 10. The C-shaped body 10 includes a first end 111 and a second end 12. The first end 111 of the C-shaped body 10 defines a screw hole 14. The second end 12 of the C-shaped body 10 includes a concave internal face 13 for contact with a rail 50 (FIG. 6). A plurality of teeth 131 is formed on the concave internal face 13 for biting the rail 50. The second end 12 of the C-shaped body 10 defines a channel 15 and a recess 16 communicated with the channel 15.

The fastener 20 includes a screw 22 engaged with the screw hole 14 and a knob 21 attached to the screw 22. The knob 21 facilitates the rotation of the screw 22. The knob 21 can be replaced with a handle.

The rope 30 includes a first end attached to the second end 12 of the C-shaped body 10 and a second end inserted through the channel 15. A block 31 is attached to the second end of the rope 30 in order to prevent the slipping of the second end of the rope 30 out of the channel 15. A hook 32 is movably connected to the rope 30.

The adjustor 40 is a cam. The cam 40 is put in the recess 16. By means of a pin 41, the cam 40 is attached to the second end 12 of the C-shaped body 10. By nature, the periphery of the cam 40 includes a furthest point that is furthest from the pin 41 and a nearest point that is nearest from the pin 41. A plurality of teeth 42 is formed on the periphery of the cam 40 in order to increase the friction between the periphery of the cam 40 and the rope 30.

Referring to FIG. 6, the hook 32 is engaged with a collar around the neck of a pet. The clamp is engaged with the rail 50. Hence, the pet is tied to the rail 50.

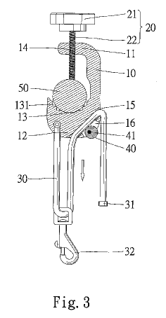

Referring to FIG. 3, when trying to run from the rail 50, the pet pulls the rope 30 as indicated by an arrowhead therein. The cam 40 is rotated counterclockwise. The furthest point of the cam 40 is moved towards the rope 30 so that the rope 30 is pinched between the wall of the channel 15 and the cam 40. Hence, the rope 30 cannot be pulled any further.

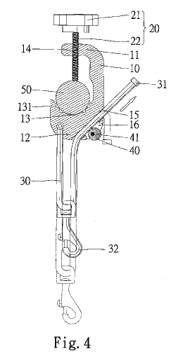

Referring to FIG. 4, wishing to reduce the effective length of the rope 30, an owner of the pet pulls the rope 30 as indicated by an arrowhead therein. The cam 40 is rotated clockwise. The furthest point of the cam 40 is moved from the rope 30. Thus, the rope 30 is not pinched between the wall of the channel 15 and the cam 40. Hence, the owner can reduce the effective length of the rope 30.

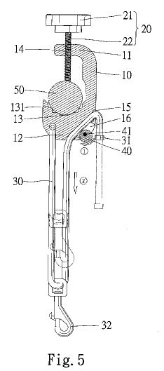

Referring to FIG. 5, wishing to increase the effective length of the rope 30, the owner rotates the cam 40 clockwise. The furthest point of the cam 40 is moved from the rope 30. Thus, the rope 30 is not pinched between the wall of the channel 15 and the cam 40. Therefore, the owner can increase the effective length of the rope 30.

The rope device according to the present invention is advantageous in several aspects. Firstly, it avoids increasing of the effective length of the rope by a pet but allows reducing of the effective length of the rope by an owner of the pet. Secondly, its operation is easy and reliable. Thirdly, its cost is low.

The present invention has been described through the detailed description of the preferred embodiment. Those skilled in the art can derive variations from the preferred embodiment without departing from the scope of the present invention. Therefore, the preferred embodiment shall not limit the scope of the present invention defined in the claims.

What is claimed is:

1. A rope device for tying a pet, the rope device comprising:
a clamp defining a channel and a recess communicated with the channel;
a rope comprising a first end connected to the clamp and a second end inserted through the channel; and
a cam put in the recess, the cam comprising a pivotal point, a furthest point from the pivotal point, and a nearest point from the pivotal point, wherein as the rope is pulled in a direction, the cam is rotated in order to move the furthest point from the rope so as to allow the rope to move between the wall of the channel and the cam, wherein as the rope is pulled in an opposite direction, the cam is rotated in order to move the furthest point towards the rope so as to pinch the rope between the wall of the channel and the cam.

2. The rope device according to claim 1 wherein the clamp comprises a C-shaped body and a fastener engaged with the C-shaped body.

3. The rope device according to claim 2 wherein the C-shaped body comprises a first end engaged with fastener and a second end connected to the rope.

4. The rope device according to claim 3 wherein the C-shaped body comprises a screw hole defined in the first end, wherein the fastener includes a screw engaged with the screw hole.

5. The rope device according to claim 4 wherein the fastener comprises a knob attached to the screw in order to facilitate the rotation of the screw.

6. The rope device according to claim 2 wherein the second end of the C-shaped body comprises a concave internal face for contact with the external object.

7. The rope device according to claim 6 wherein the C-shaped body comprises a plurality of teeth formed on the concave internal face for biting the external object.

8. The rope device according to claim 1 wherein the cam comprises a plurality of teeth formed thereon in order to increase the friction between the cam and the rope.

9. The rope device according to claim 1 comprising a hook movably connected to the rope on one hand and for hooking a collar for the pet.
